(19) United States
(12) Patent Application Publication
(10) Pub. No.: US 2015/0198228 A1
(43) Pub. Date: Jul. 16, 2015

(54) GEAR COMBINATION WITH A PLANETARY DIFFERENTIAL IN THE FORM OF A WILDHABER-NOVIKOV SPUR GEAR DIFFERENTIAL

(71) Applicant: Schaeffler Technologies GmbH & Co. KG, Herzogenaurach (DE)

(72) Inventors: Thorsten Biermann, Wachenroth (DE); Anja Kuerzdoerfer, Herzogenaurach (DE); Sebastian Welker, Herzogenaurach (DE)

(73) Assignee: Schaffler Technologies GmbH & Co. KG, Herzogenaurach (DE)

(21) Appl. No.: 14/418,252

(22) PCT Filed: Jun. 4, 2013
(86) PCT No.: PCT/EP2013/061469

§ 371 Date: Jan. 29, 2015

(30) Foreign Application Priority Data
Jul. 31, 2012 (DE) 102012213392.5

(51) Int. Cl. F16H 48/11; F16H 48/40

(52) U.S. Cl. CPC F16H 48/11; F16H 48/40

(57) ABSTRACT

A gear combination comprising a first planetary gear stage and a second planetary gear stage, each formed by a planet and a sun, wherein said planet is rotatably secured on a planetary carrier comprising pin axes, said pin axes arranged a radial distance from a main axis through said suns, a first gear wheel comprising a first tooth, said first tooth secured to said first gear wheel, wherein said first tooth has a first tooth flank, a second gear wheel comprising a second tooth and a tooth gap, said second tooth secures to said second gear wheel, wherein said second tooth has a second tooth flank, a first tooth arrangement formed by said first tooth and, a second tooth arrangement formed by said second tooth and said tooth gap, wherein said first gear wheel and said second gear wheel engage via said first tooth flank and said second tooth flank.

### CROSS-REFERENCE TO RELATED APPLICATIONS

The present application is the U.S. national stage application pursuant to 35 U.S.C. §371 of International Application No. PCT/EP2013/061469, filed Jun. 4, 2013, which application claims priority from German Patent Application No. DE 10 2012 213 392.5, filed Jul. 31, 2012, which applications are incorporated herein by reference in their entireties.

### TECHNICAL FIELD

The disclosure relates to a gear combination having a superposition gear stage which can be designed as an additional planetary gear stage that is connected to a planetary gear, whereby the planetary gear is provided with at least two planetary gear stages, each of which planetary gear stages is formed by at least one set of planets and a sun, whereby the gear wheels in the planetary gear are in tooth engagement with each other in such a way that in each of the tooth engagements at least one first tooth engages in a positive-fitting manner on a first tooth arrangement formed by first teeth in a tooth gap of a second tooth arrangement formed by second teeth and whereby the first tooth contacts in at least one tooth contact at least a second tooth flank of the second tooth delimiting the tooth gap on one side on the second tooth arrangement with a first tooth flank, whereby the first teeth of the first tooth arrangement have a tooth flank profile as seen in the cross-section through the tooth arrangements in the tooth engagement, whereby the tooth flange profile is curved in a concave manner and whereby the second teeth of the second tooth arrangement have a tooth flank profile that is curved in a convex manner in the same cross-section, such that the tooth flanks of the first tooth and the second tooth that contact each other in the tooth contact are curved in the same direction at least in the tooth contact, whereby, further, the planets are arranged about bearing regions of a planetary carrier comprising pin axes in a rotatable manner, whereby all the pin axes have the same radial distance from a main axis through the suns, about which the planetary carrier is mounted in a rotatable manner.

### BACKGROUND

DE 10 2009 032 286 A1 discloses a planetary differential with a generic planetary gear. The planetary differential has two planetary stages, each of which is respectively formed by a planetary set and a sun. The sun and the planets are gears with spur gearing designed as involute gearing. The planet gears are mounted at a radial distance from the main axis of the planetary differential to allow the sun to rotate around it on planet pins and mesh with the sun gear.

The planet pins are fixed on a planet carrier. The planetary gears of a set and the corresponding sun gear of each planetary stage so mesh with each other that in each of the meshings, at least a first tooth in a stage formed by circumferentially-spaced first teeth positively engages a first tooth in a tooth gap of a second gear formed by the second tooth in a positive fitting manner. In this case, the first tooth contacts a first tooth flank, at least a second tooth flank contacts a second tooth, which together with a further second tooth delimit the tooth gap in the circumferential direction of the gear wheel. The teeth contact one another in the tooth contact, as is customary with spur gears.

Meshing refers to the movable positive-fitting connection of gear teeth of a gear wheel and a counter gear wheel by mutual engagement of teeth of the gear wheel in the counter gear in tooth gaps, and vice versa.

Such planetary differentials are perfectly suitable for installation in transfer cases. Furthermore, the planetary gear sets, planetary gear units and planetary differentials are ideally suited for use in electric motor drive units for hybrid drives.

Such a drive unit is disclosed in DE10 2008 061 946 A1. The drive unit has a main drive and an auxiliary drive. The main drive is connected by gearing via a planetary gear set with a planetary differential. A planetary differential is characterized essentially by two sets of differential gears, each formed by a set of planetary gears. Each of the differential planetary gears is rotatable about an axis of rotation on a planetary pin, which corresponds to the axis of symmetry of the planetary pin. The axes of rotation of the planetary gears are aligned parallel to the axis of rotation of the driven wheels, and thus the rotation axis of the sun gears of the planetary differential. The coaxial axes of rotation of the sun gears are concentric to the differential and lie on the major axis of the drive unit.

Moreover, the main axis of the drive unit still combines the axes of rotation of the drive shafts of the main and auxiliary drive in itself. The difference shafts of the planet differential are sun gears, which are connected, for example, to a drive shaft driving a vehicle wheel. Each of the sun gears meshes with one of the sets of balancing planetary gears.

Additional torques can be incorporated in the planetary differential via a superposition gear through the auxiliary drive, and their distribution to the wheels influenced. The main drive and auxiliary drive, in this case—electric motors, are arranged coaxially with each other. The superposition gear is formed by three mutually coupled planetary drives. Such drive units are independent of other power sources, e.g. they can be independent of internal combustion engines, or installed together with the latter.

In the case of planetary gear differentials as described DE 10 2009 032 286 A1 and in a drive unit according to DE 10 2008 061 946 A1, the tooth arrangement of the first planetary gears meshes with the tooth arrangement of the second planetary gears. The number of teeth of the first planetary gears preferably corresponds to the number of teeth of the tooth arrangement of the second planetary gears, but may also optionally be different. At the same time, the tooth arrangement of the planet gears of one of the sets of planetary gears meshes with the tooth arrangement of only one sun gear, without the tooth arrangement of the planet gears of this set meshing with the tooth arrangement of the other sun gear. For this to be possible, the planetary gears of a set must be “longer”, i.e. axially wider than the tooth arrangement of the planetary gears of the other set and thereby overlap the other sun gear without touching the latter axially.

Since, in order to mesh the longer planetary gears with the shorter planetary gears, one of the sun gears must overlap the latter without contacting it axially; the axially-overlapped sun gear has a smaller number of teeth and thus a smaller diameter, than the adjacent sun gear. Alternatively and preferably, however, the tooth arrangement of the axially-overlapped sun gear has the same number of teeth as the other but is, however, designed with a smaller tip circle. The same number of teeth and the same diameter of the planetary gears of the two sets as each other are provided in this case.

The different tip diameters of the sun gears can be achieved by profile displacement that is known to persons skilled in the art. The tooth contact of the sun gears with the larger tip circle can be achieved through positive profile displacement, while the corresponding tooth contact in the tip circle of the smaller sun gears is achieved by negative profile displacement. The tip circle is an imaginary circle that surrounds the teeth of a tooth arrangement with equally large teeth outside. The tip circle diameter is accordingly the outer diameter of such a spur tooth arrangement. It determines the space requirements of a gear in all radial directions from the rotation axis.

At the same time, the axial distance of the overlapped sun gear to the planetary gear with which meshes, is small, so that the short gear wheels can mesh with the latter. The matching ratios between the planetary gear wheels of the first set and the first sun gear and between the planetary gear wheels of the second set and the second sun gear are provided in this case.

Thus, there exists a long felt need to make available a closed differential cage for a Wildhaber/Novikov differential, which has a particularly good tooth arrangement and has a very compact design at the same time while particularly durable but inexpensive components can be used.

### SUMMARY

The object of the present disclosure is to provide a closed differential cage for a Wildhaber/Novikov differential, which has a particularly good tooth arrangement and has a very compact design at the same time. This object is achieved in a generic gear combination whereby all the pin axes have the same radial distance from a main axis through the sun, whereby the planetary carrier is rotatably mounted around the main axis.

At this point, it should be made clear briefly, that by suns are to be understood sun gears, which serve the function of sun gears. By planets are to be understood planetary gears, i.e. gear wheels that are arranged circumferentially around the sun.

Preferred embodiments are claimed in the sub-claims and will be explained in more detail below.

Thus, it is preferred that the superposition stage has a common pin which extends through a planet of the superposition stage and also through a planet of a first planetary gear set of the planetary gear in order to make the best use of the available space.

It is also of advantage if the sun of the at least two planetary gear stages has the same number of teeth and/or are designed as planetary gears having the same number of teeth, in order to ensure efficient operation.

A preferred embodiment is also characterized in that the planet carrier is constructed as a differential cage with a cover, whereby the differential cage and the cover are formed as the first and second parts of the planet carrier. These parts, i.e. the two parts of the planet carrier in the form of a cover and a differential cage, thus form the whole planet carrier.

It is also expedient if the cover or differential cage is formed as a shaped sheet metal part having the same wall thickness. The production mechanisms are particularly simple, resulting in low cost. A force-absorbing refinement is possible and that is beneficial for the longevity of the gearing.

It has been particularly advantageous to have found a balance between low weight and high strength through the choice of a wall thickness of the cover and/or differential cage between 4 mm and 10 mm, preferably 7 mm.

Further, it is preferred if the housing of the differential cage has a fit tolerance class X6 to 7, preferably H6 to H7, in particular on the outside thereof. A drive wheel can then be very easily centered.

If both in the differential cage as well as in the cover, equally-spaced holes for receiving planet bearing bolts are provided at the same radial distance from the main axis of each, then equivalent bore rims can be made in the two components, resulting in the efficient functioning of the planetary gear.

In order to keep costs to a minimum while improving the durability, the material surrounding the holes should be hardened, preferably induction hardened.

The holes can be configured as bore holes to provide pin bearings for the planetary pins.

It has also been found to be useful if the differential cage is formed with a stepped diameter, preferably with multiple steps, and is reduced under a drive wheel. This is particularly advantageous to enable the cover to have higher stiffness and a more favorable mass distribution.

The contact surface for the drive wheel with the said bore rim is provided with bearing tolerances to achieve square form and flatness. Equally, the contact area with the bore rim can also be provided with bearing tolerances to achieve square form and flatness. A flange thus forms the bearing seat.

The bore rim, which is provided in two possible sub-planetary carriers having the same radial distance from a main axis around which the sun wheels rotate, is also advantageously used by other planetary gears. This would be, for example, in a gear combination with a superposition stage which is formed as an additional planetary stage, whereby a planetary gear according to the invention is used, advantageously if the superposition stage has a common pin that extends through a planet of the superposition stage, and through a planet of a first planetary gear set of the planetary gear possibly serving as a differential.

The teeth of the first tooth arrangement have a tooth flank profile that is concave in cross-section when regarded through the tooth arrangement in the tooth engagement. On the other hand, the teeth of the second tooth arrangement in the same cross-section have a convex curved tooth flank profile. The tooth flanks in tooth contact with the first tooth arrangement and the second tooth arrangement are correspondingly curved in the same direction, at least in the tooth contact.

As described above, the teeth of the tooth arrangements of the one gear have concave flank geometry. The concave flank geometries extend either continuously, ideally arc-shaped, or with an uneven course of the flank line inward in the respective tooth, so that between two facing tooth flanks a tooth gap in the cross-section of the gear has an outline profile, for example, in the form of a circular arc, alternatively in the form of gothic profiles or profiles with oval pattern (regarded as a semi-ellipse over the long half axis). The flank profile of the teeth themselves according appears with an outline in the form of a circular arc, cup or bell in the same cross-section. It is not excluded that the tooth tips and the gaps at the tooth root are flat or in the form of a flattened circular arc, i.e. that the respective profile appears to be cut, so to speak, at its peak.

The teeth engaging in the tooth gaps of the above-mentioned gear of the other counter-tooth arrangement have convex flank geometries. The convex flank geometries are either continuous or discontinuous and curved to extend outwards, so that the flank profile of the teeth in the cross-section of the gear in outline appears, for example, in the form of circular arc profiles (classic form of the Novikov tooth arrangement), or alternatively gothic profiles or profiles with oval pattern (semi-ellipse). The tooth gap outline between two of the facing teeth viewed in cross-section will then accordingly have the shape of a circular arc, cup or bell. It is again possible that the tooth tips and the gaps at the tooth root are flat or in the form of a flattened circular arc, i.e. that the respective profile appears to be cut, so to speak, at its peak.

In the classic form, this is referred to as Wildhaber-Novikov tooth arrangement and is characteristic in that a part of a concave tooth flank profile of the teeth of a toothed wheel always engages with a part of a convex tooth flank profile of the teeth of a tooth arrangement of the counter gear. Viewed in cross-section, laterally to the axis of rotation of both the gears located in the meshing gear wheels, which lie against each other in the tooth engaging flank lines of the tooth flank profile of the flanks of the concave and convex tooth and are thus curved in the same direction, so that the flanks of the convexly bulged teeth appear to nestle in the flanks of the concave curved teeth. Such a combination results in favorable pressure ratios between the teeth. An increased load capacity is expected in terms of the surface pressure for such a gear. In addition, self-centering of the suns with respect to the main axis of a planetary gear is provided, when this is usually arranged on an unequal number of uniformly circumferentially spaced number of planetary gears supported by flank contact. The tooth height of such gearing is less than, for example, an involute gear with the same module. The weight of such a planetary gear is therefore compared, for example, with those with less involute tooth arrangement.

The sun in at least one of the planetary gears is a gear with teeth where the tooth flank has a continuous concave profile. Accordingly, the planets of the set of each counter gear have teeth with a continuous convex tooth flank profile.

A planetary gear according to the invention can have two planetary stages, in which the planetary gears of a planetary stage mesh with the gears of the second planetary stage. The planets within a planetary set of the first planetary stage are gear wheels with teeth having a concave tooth flank profile. The planets of the other planetary set have counter gears having a convex tooth flank profile.

A planetary gear according to the invention can have two planetary stages, whereby the first planets of a first stage planetary gear mesh with the gears of a second planetary stage. The planets within the planetary gear set of the first stage are planetary gears with teeth having a concave tooth flank profile. The second planets of the second planetary stage have counter gears having a convex tooth flank profile. The first planets mesh with a first sun, which has a counter gear with teeth having a convex tooth flank profile. The second planets mesh with a second sun having a gear with teeth having a concave tooth flank profile.

A planetary differential according to the invention with a planetary gear according to the invention has a planetary carrier as the differential cage and as the drive shaft (summation shaft of the planetary drive). Furthermore, the planetary differential is formed by two planetary gear sets and two suns. The planets of the planetary gear sets are mounted together on the planetary carrier which can be in several parts and whose individual parts are firmly torque-coupled together. The sun gears as differential shafts of the differential are coupled to the output shafts, each of which, for example, leads to a vehicle wheel.

In the planetary differential, preferably both planetary stages are combined with the first set and the first sun and with the second set and the second sun with the first and second tooth arrangements. The suns of the planetary differential preferably have a common axis of rotation which corresponds to the main axis of the differential.

A gear can be a distribution gear with a drive and three takeoffs. Alternatively, the gear is part of a drive unit in which at least one electric motor is integrated. The gear has a planetary differential in one embodiment of the invention and is accordingly formed by two sets of planets and one sun per set. Both sets are mounted on a common planetary carrier that can also be in multiple parts, but the individual parts are coupled together with conceivable torque-coupling means. The sun gears are coupled to output shafts, each of which, for example, leads to a vehicle wheel. In addition, the gear can be provided with a third planetary stage. The third planetary stage is formed from a third set of planets in toothed mesh with a third sun. The planetary carrier can be driven via the third planetary gear stage. The planetary gears of the third set are rotatably mounted on the same planetary carrier as the sets of planetary gears of the planetary differential. At least one, or alternatively two or three of the planetary gears, have at least a combination of tooth arrangement with concave and convex tooth flank profiles.

Even further, according to aspects illustrated herein, there is provided a gear combination having a superposition gear stage which is designed as an additional planetary gear stage that engages a planetary gear, the gear combination comprising a first planetary gear stage and a second planetary gear stage, wherein the first planetary gear stage and the second planetary gear stage are each formed by a planet and a sun, wherein the planet is rotatably secured on a planetary carrier comprising pin axes, the pin axes arranged a radial distance from a main axis through the suns, about which the planetary carrier is rotatably secured, a first gear wheel comprising a first tooth, the first tooth secured to the first gear wheel, wherein the first tooth has a concave tooth profile and a first tooth flank, a second gear wheel comprising a second tooth and a tooth gap, the second tooth secures to the second gear wheel, wherein the second tooth has a convex tooth profile and a second tooth flank, a first tooth arrangement, the first tooth arrangement formed by the first tooth and, a second tooth arrangement, the second tooth arrangement formed by the second tooth and the tooth gap, wherein the first gear wheel and the second gear wheel engage via the first tooth flank and the second tooth flank, wherein reducing the tooth gap of the second tooth arrangement.

### BRIEF DESCRIPTION OF THE DRAWINGS

Various embodiments are disclosed, by way of example only, with reference to the accompanying drawings in which corresponding reference symbols indicate corresponding parts, in which:

FIG. 1 is a schematic view of a planetary differential, whereby, according to the invention, the pin axes of the planets of two planetary sets have the same height, i.e. they are spaced radially equally from a main axis, unlike as is shown in the figure,

FIG. 2 shows a gear combination which uses the planetary gear mechanism shown in FIG. 1 where the pin axes, according to the invention, are radially equidistant from the main axis,

FIG. 3 shows a cross-sectional view of a variant of a gear combination,

FIGS. 4A and 4B are side views of the tooth arrangement used, at least between the planets and the sun,

FIG. 5 shows a perspective view of the planetary carrier,

FIG. 6 shows a longitudinal section through the planetary carrier of FIG. 5,

FIG. 7 shows another longitudinal sectional view through the housing structure of FIG. 5,

FIG. 8 shows a view from the side of the cover of the planetary carrier,

FIG. 9 shows a view from the side of the differential cage with the attached output element,

FIG. 10 shows a view from the inside on one side of the assembled planetary gear,

FIG. 11 shows a view of the planetary gear without the suns and planets in place,

FIG. 12 shows a view of a section of a planetary gear according to the invention corresponding to FIG. 11, and,

FIG. 13 shows a view of a section of a planetary gear according to the invention corresponding to FIG. 12.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

The figures are merely schematic in nature and serve only for the understanding of the invention. The same elements are given the same reference numerals.

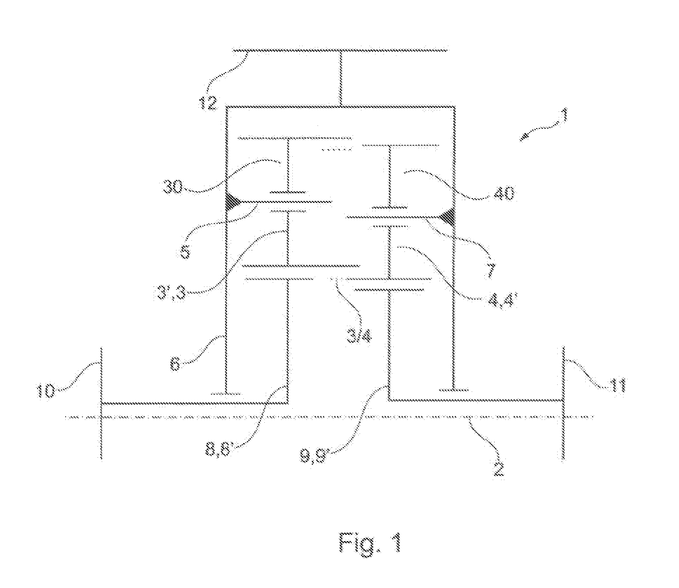

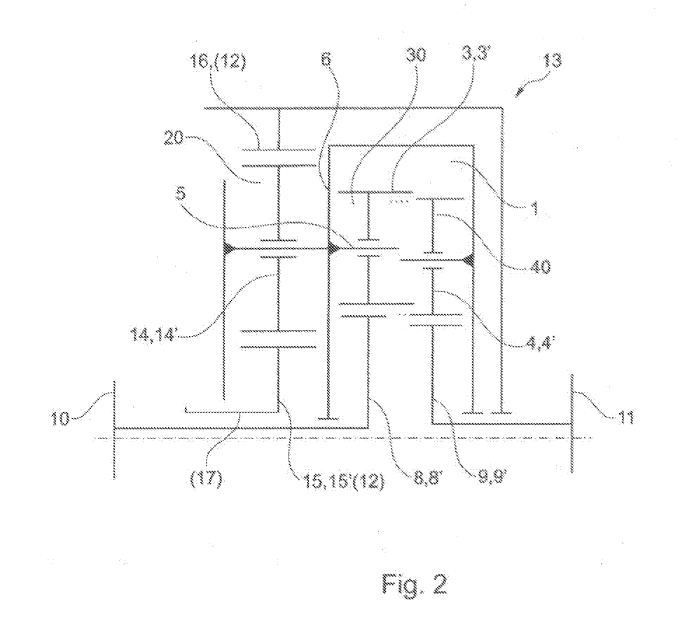

FIG. 1 shows an embodiment of planetary differential 1 according to the invention in a simplified schematic half illustration along main axis 2 of planetary differential 1. Planetary differential 1 has two planetary gear stages 30 or 40 each provided with a planetary set 3 or 4, of which only one planet 3/gearwheel 3′ or planet 4/gear 4′ is shown. Planets 3 are each rotatably supported on planetary pin axis of a pin, not shown, which is secured to planet carrier 6, having a first radial distance from main axis 2. Planets 4 are rotatably supported on a planet pin axis 7 of a pin, not shown, which is secured at a second radial distance from main axis 2 of planetary carrier 6. The first radial distance is different, however, in the present invention, as shown in FIGS. 1 and 2, and is equal to the second radial distance.

Planet 3 always meshes with planet 4, as symbolized by dashed line 3/4. However, shorter planets 3 with sun 8 do not mesh with sun 9. Suns 8 and 9 are gears 8′ and 9′ and are only half shown. Each of longer planets 4 meshes with sun 9 but not with sun 8. Suns 8 and 9 are rotatable relative to planet carrier 6 and relative to one another. Each is also connected to output shaft 10 or 11. The axis of rotation of sun 8 or 9 corresponds to main axis 2. There is drive element 12 in the planetary differential that may optionally be a bevel gear, spur gear, belt or chain wheel and is fixed to planetary carrier 6.

FIG. 2 shows an embodiment of gear 13 according to the invention with planetary differential 1 according to FIG. 1 in a simplified schematic view taken along main axis 2 of differential planet 1 or 2 along the main axis of gear 13.

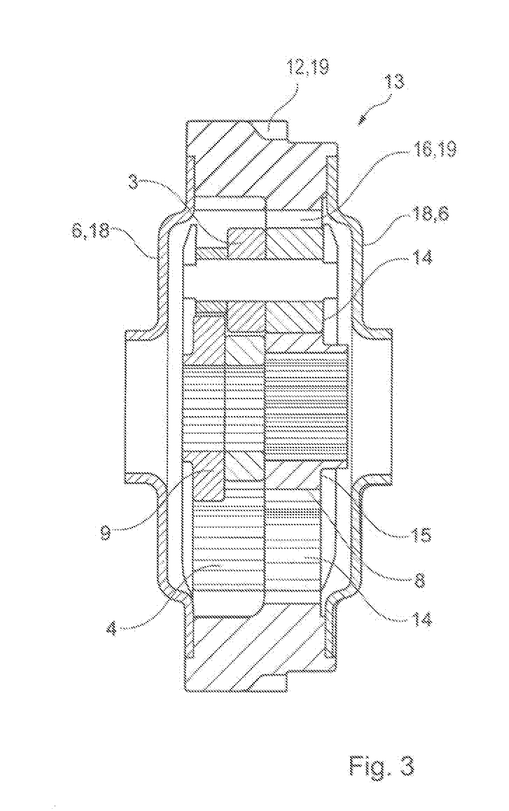

FIG. 3 shows such gear 13 in a longitudinal section along the major axis 2. Apart from planetary stages 30 and 40 of planetary differential 1, gear 13 has another planetary stage 20. Planetary stage 20 is formed by planetary set 14, of which only planet 14, which is gear wheel 14′, is shown. Planet's 14 mesh with third sun 15. Sun 15 is gear wheel 15′, which is only half shown. Planets 14 are rotatable about pin axis 5 together with shorter planet 3 around a planetary pin on planetary carrier 6. Planets 14 also mesh with ring gear 16.

In the illustration according to FIG. 2, sun 15 or ring gear 16 are, selectively, either one or the other, drive element 12 of gear 13. When gear 13 is a distributor gear, ring gear 16 is drive element 12. In this case, sun 15 is coupled with further output shaft 17, which for example, leads to an axle gear from the distributor gear. In a drive unit with at least one electric motor, either of the elements, either sun 15 or ring gear 16 can be driving element 12, or both sun 15 and ring gear 16 can be used in the drive unit as drive elements 12 of the gear.

In the illustration according to FIG. 3, planetary carrier 6 is formed by two shell-like elements 18, 19 that are axially fixed to one another via a combination element. Ring gear 16 and drive member 12 are integrally combined in combination element 19 in the form of a spur gear. Simultaneously, a spacer and mounting flange are combined in combined module 19. Gear 13 according to FIG. 3 can be used as a distributor gear in which suns 8, 9 and 15 can be respectively connected to an output shaft.

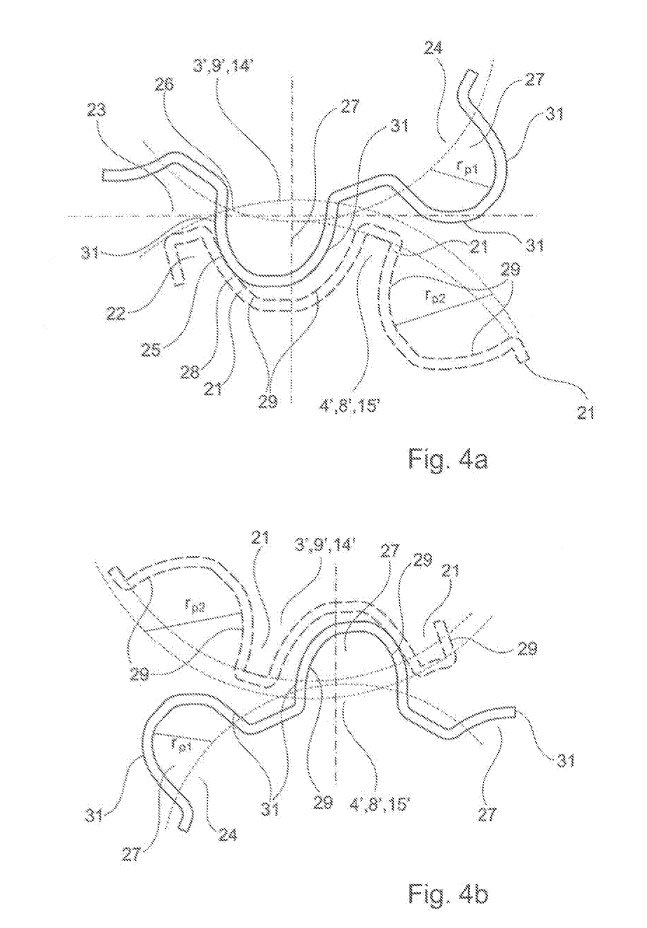

FIG. 4a and FIG. 4b respectively show a detail of a cross-section in a cross-sectional plane that is vertical to main axis 2, with the possible combinations of gear wheels, gear 3′ with gear 4′ and at the same time with gear 8′, gear 4′ with gear 3′ and simultaneously with gear 9′ and/or gear 14′ with gear 15′ of the above-described embodiments illustrated in FIG. 1 to FIG. 3. The gears have the same number of teeth. In particular, the suns have the same number of teeth as each other, just as the planets have the same number of teeth as each other.

Gear wheels 3′, 4′, 8′, 9′, 14′ and 15′ so mesh with one another that in each of the tooth meshes at least first tooth 21 of a plurality of circumferentially distributed teeth 21 meshes in a form-fitting manner with first tooth arrangement 22 in tooth gap 23 of second tooth arrangement 24. First tooth 21 contacts with first tooth flank 25, while at least second tooth flank 26 of tooth gap 23 delimits at least one tooth contact 28 on one side of second tooth 27 of second tooth arrangement 24. First teeth 21 of first tooth arrangement 22 have tooth flank profile 29 that is respectively concave. Second teeth 27 of second tooth arrangement 24 each have a convex curved tooth flank profile 31. Tooth flanks 25 and 26 of first tooth 21 and second tooth 27 in contact in tooth contact 28 are accordingly at least in tooth contact 28 in the illustration according to FIG. 4a, e.g. in the image on the left and in the illustration according to FIG. 4b, arched in the same direction in the image on the right.

As is apparent from the illustration according to FIG. 4a, first teeth 21 of first tooth arrangement 22 with concave profiled tooth flank 29 extend to toothed wheels 4′, 8′ and 15′. Second teeth 27 of second tooth arrangement 24 each have convex tooth flank profile 31 and are carried by gear wheels 3′, 9′ and 14′. As is apparent from FIG. 4b, first teeth 21 of first tooth arrangement 22 are formed with the concave profiled tooth flank 29 of gear wheels 3′, 9′ and 14′. Second teeth 27 of second tooth arrangement 24 have convex profiled tooth flank 31, and are carried by gear wheels 4′, 8′ and 15′.

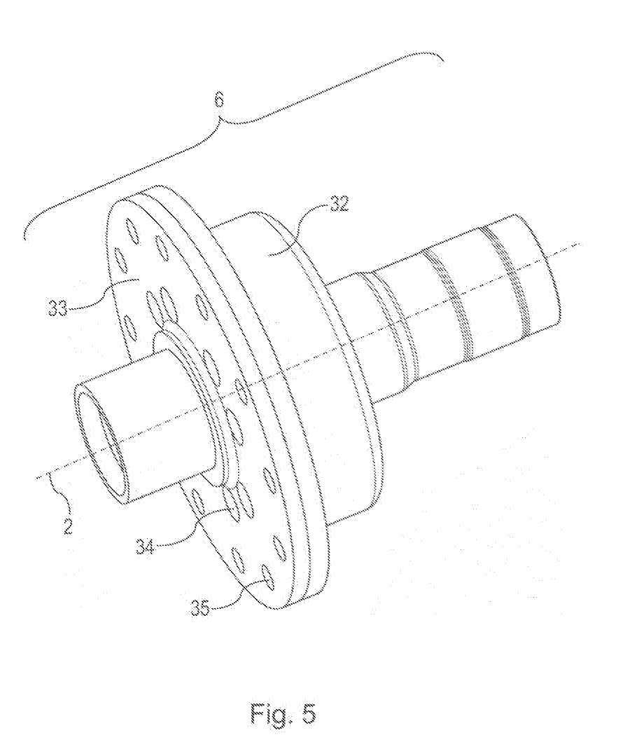

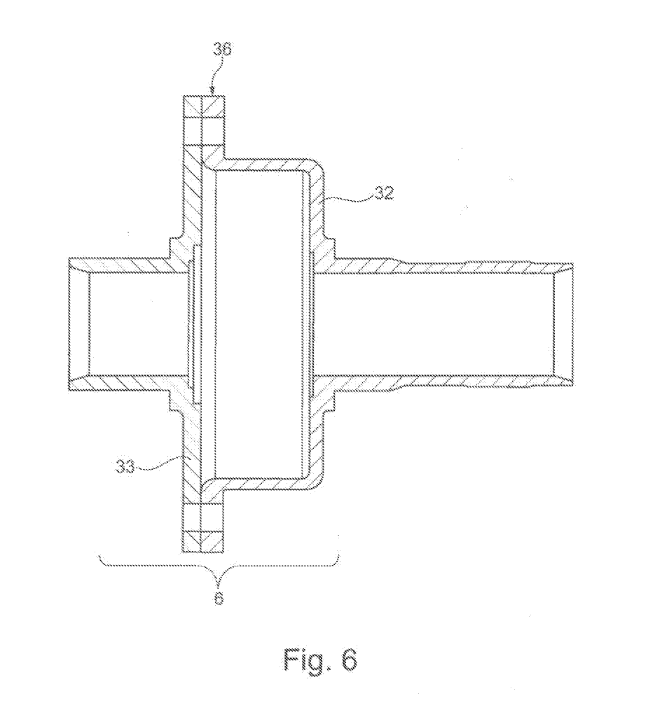

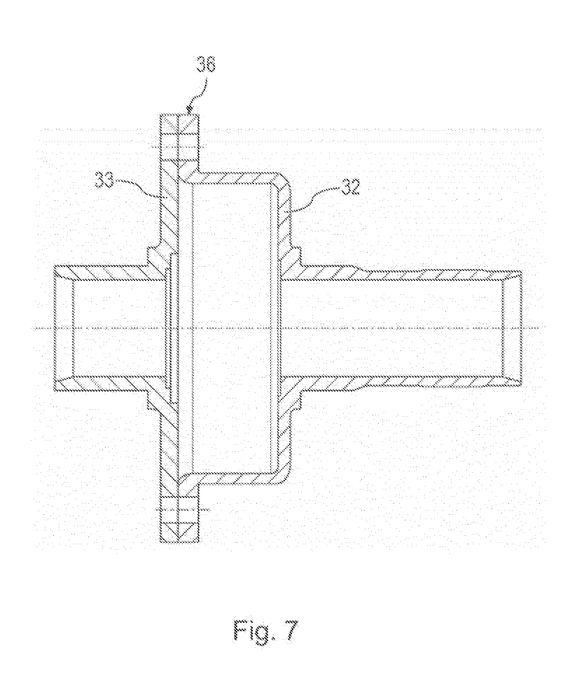

In FIGS. 5 to 7, differential cage 32 and cover 33 are shown, which together form planetary carrier 6. Both differential cage 32 and cover 33 have holes 34, which are formed as through-holes.

Holes 34 are provided on a pitch circle which has both the differential cage 32, as well as the cover 33 at the same radial distance from main axis 2. Fixing recesses 35 are disposed radially outside thereof, in order to enable bolting or screwing of the two planetary carriers to the portion of flange 36, i.e. differential cage 32 and cover 33. The combination of differential cage 32 and cover 33 may also be referred to as the differential cage. Apart from such a differential cage, there is also an axle housing, which acts in the sense of a differential housing that houses the planetary carrier.

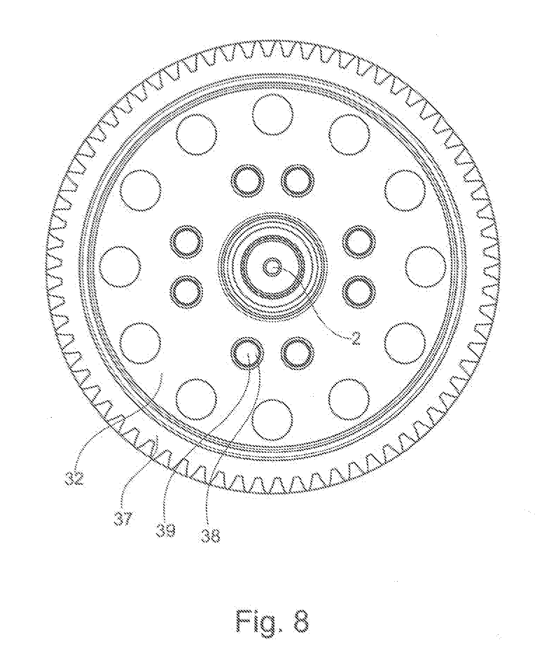

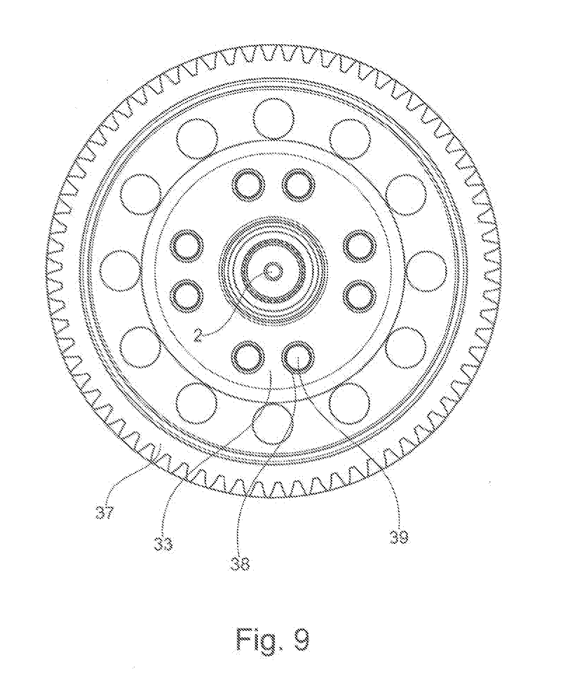

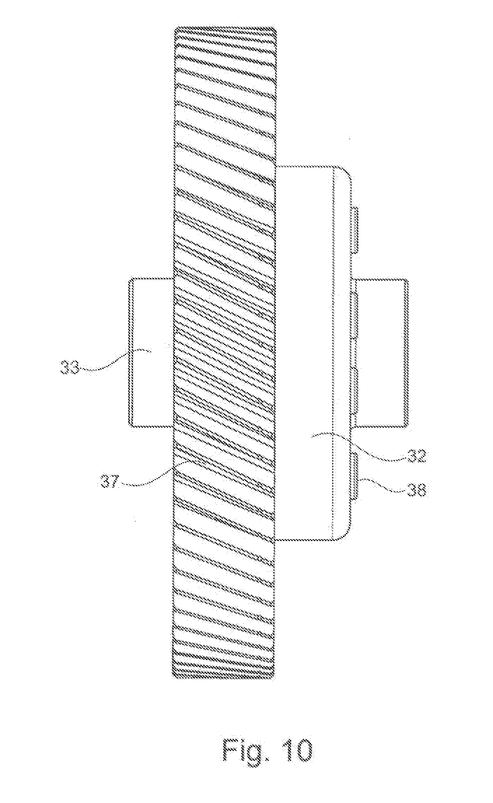

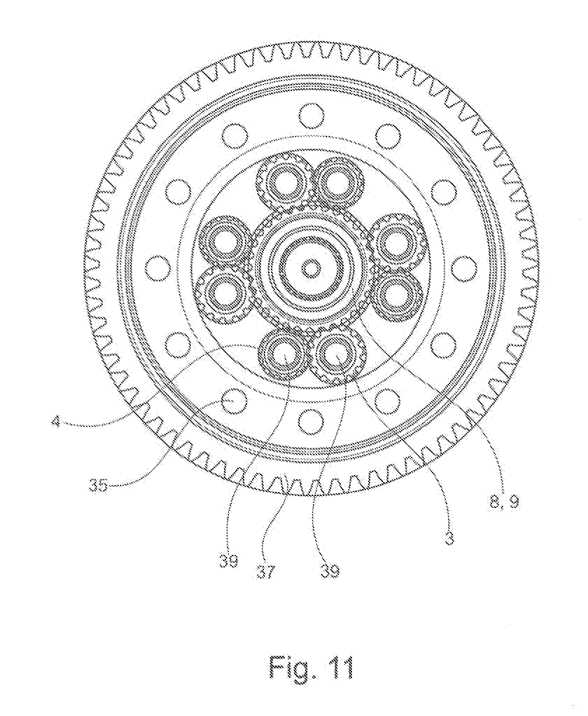

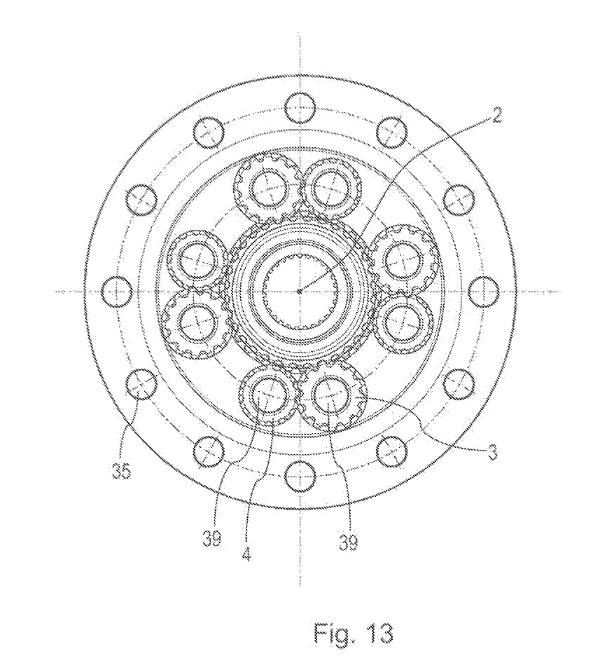

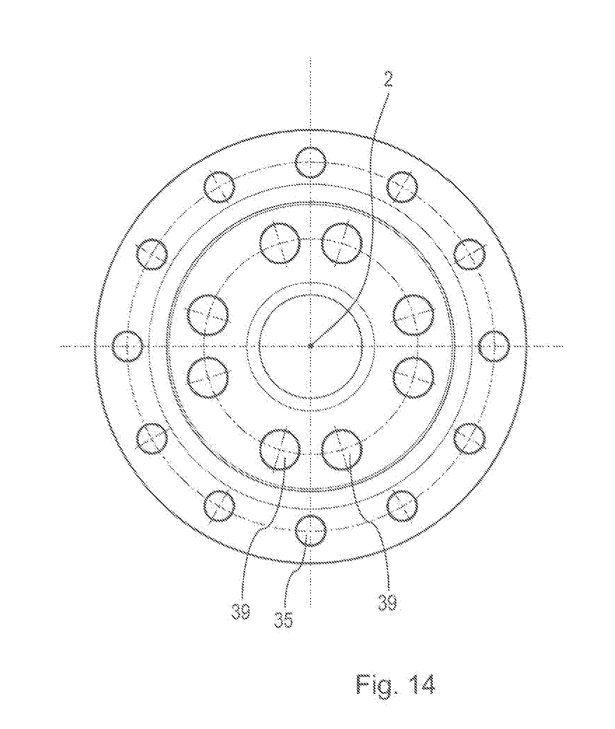

As shown in the overview of FIGS. 8 and 9, there is spur gear 37 in the area of flange 36. The overview also shows in FIGS. 8 and 9 holes 34 in which sleeves 38 are located that are equally radially spaced from main axis 2. Pins 39 inserted into holes 34 and through which respective pin axes 5 and 7 extend centrally can be seen in FIG. 11, and as shown in FIG. 13.

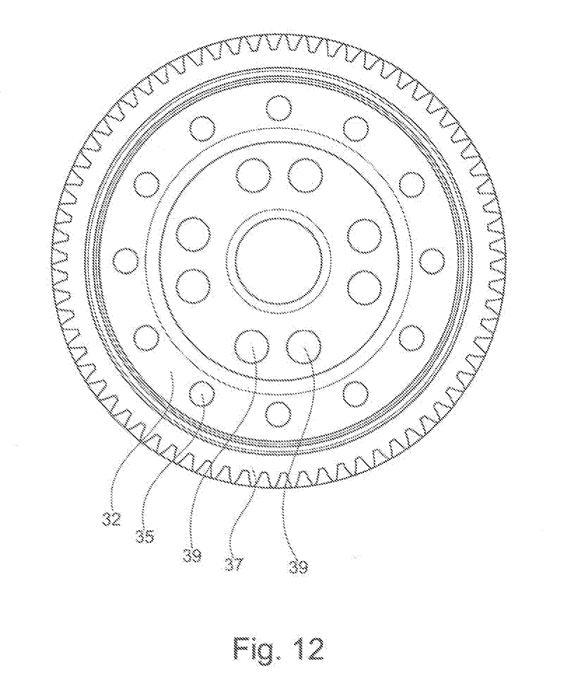

FIGS. 13 and 14 do not show spur gear 37 of FIGS. 11 and 12. The uniform distribution of holes 34, in which pins 39 are arranged around main axis 2 for both planet 3 and planet 4, however, is, inter alia, clearly shown in FIG. 14.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE NUMBERS

1 Planetary differential
2 Main axis
20 Planetary stage
3 Planet
3′ Gear
4 Planet
4′ Gear
40 Planetary stage
5 Pin axis
6 Planetary carrier
7 Pin axis
8 Sun
8′ Gear
9 Sun
9′ Gear
10 Output shaft
11 Output shaft
12 Drive element
13 Gear
14 Planet
14′ Gear
15 Sun
15′ Gear
16 Ring gear
17 Output shaft
18 Cup-shaped elements
19 Combined module
20 Planetary stage
21 Tooth
22 Tooth arrangement
23 Tooth gap
24 Tooth arrangement
25 Tooth flank
26 Tooth flank
27 Tooth
28 Tooth contact
29 Tooth flank profile
30 Planetary stage
31 Tooth flank profile
32 Differential cage
33 Cover
34 Hole
35 Fixing recess
36 Flange
37 Spur
38 Sleeve
39 Pin

What is claimed is:

1-10. (canceled)

11. A gear combination having a superposition gear stage which is designed as an additional planetary gear stage that engages a planetary gear, said gear combination comprising:
a first planetary gear stage and a second planetary gear stage, wherein said first planetary gear stage and said second planetary gear stage are each formed by a planet and a sun, wherein said planet is rotatably secured on a planetary carrier comprising pin axes, said pin axes arranged a radial distance from a main axis through said suns, about which said planetary carrier is rotatably secured;
a first gear wheel comprising a first tooth, said first tooth secured to said first gear wheel, wherein said first tooth has a concave tooth profile and a first tooth flank;
a second gear wheel comprising a second tooth and a tooth gap, said second tooth secures to said second gear wheel, wherein said second tooth has a convex tooth profile and a second tooth flank;
a first tooth arrangement, said first tooth arrangement formed by said first tooth; and,
a second tooth arrangement, said second tooth arrangement formed by said second tooth and said tooth gap, wherein said first gear wheel and said second gear wheel engage via said first tooth flank and said second tooth flank, wherein reducing said tooth gap of said second tooth arrangement.

12. The gear combination recited in claim 11, wherein said superposition gear stage comprises a common pin that extends through said planet of said first planetary gear stage and through said planet of said second planetary gear stage.

13. The gear combination recited in claim 11, wherein said suns of said first planetary gear stage and said second planetary gear stage comprise the same number of teeth, and/or said gears formed as a planet have the same number of teeth.

14. The gear combination recited in claim 12, wherein said planetary carrier comprises a differential cage with a cover, whereby said differential cage and said cover are formed as a first and a second part of said planetary carrier.

15. The gear combination recited in claim 14, wherein said cover and said differential cage are formed as shaped sheet metal parts having the same wall thickness.

16. The gear combination recited in claim 15, wherein said wall thicknesses of said cover and/or said differential cage are between 4 mm and 10 mm, preferably 7 mm.

17. The gear combination recited in claim 14, wherein said housing of said differential cage has a tit tolerance class X6 to 7, preferably H6 to H7, in particular on the outside thereof.

18. The gear combination recited in claim 14, wherein said differential cage and said cover each comprise equally spaced holes at a radial distance from said main axis to receive planet bearing pins.

19. The gear combination recited in claim 18, wherein said holes surrounding the material are hardened, preferably induction hardened.

20. The gear combination recited in claim 14, wherein said differential cage is formed to be diameter-stepped, preferably formed to be repeatedly stepped and/or is formed offset from a drive wheel, and preferably has bores for securing said drive wheel.
